(19) United States
(12) Patent Application Publication
(10) Pub. No.: US 2007/0175997 A1
(43) Pub. Date: Aug. 2, 2007

(54) Electronic business card case

(76) Inventor: Jason Hsieh, Taichung (TW)

Correspondence Address: HERSHKOVITZ & ASSOCIATES, 2845 DUKE STREET, ALEXANDRIA, VA, 22314, US

(21) Appl. No.: 11/345,382

(22) Filed: Feb. 2, 2006

(51) Int. Cl. G06K 7/10

(52) U.S. Cl. 235/454

(57) ABSTRACT

An electronic business card case has a body, an image scanning device and an image processing circuit. The image scanning device is mounted inside the body to generate a digital image of a business card, The image processing circuit is mounted inside the body, is connected to the image scanning device and comprises a digital signal processor having built-in character recognition software, an input unit, an output unit, a memory card slot and a communication interface. The digital image generated by the image scanning device can be viewed and edited directly via the output unit and the input unit, saved in a database format after character recognition processing, stored to an external memory card via the memory card slot, uploaded to or downloaded from an external device via the communication interface.

### BACKGROUND OF THE INVENTION

1. Field of the Invention

The present invention relates to a business card case, and more particularly to an electronic business card case that saves business cards as digital images through scanning and character recognition processing.

2. Description of Related Art

Generally at commercial and social events, exchanging of business cards is common. A business card may include such information such a name of a business, information concerning the nature of the business, a corporate position, a business address and one or more phone numbers.

To effectively maintain a huge number of business cards, many people have electronic address books in devices such as portable computer, PDA and the like. However, a business card may include text information and unique graphic trademarks or logos. Even though the text information can be keyed into the electronic devices, the unique graphic trademarks and logos cannot be entered, which is not convenient.

Character information must be input to a computer by keyboard entry. In other words, even though the character information is available on the business card, the written information cannot be automatically processed by conventional electronic device. Consequently, the electronic devices do not generally have all information from available business cards because manual entry is time consuming and inconvenient.

To overcome the shortcomings, the present invention provides an electronic business card case to obviate or mitigate the aforementioned problems.

### SUMMARY OF THE INVENTION

The main objective of the present invention is to provide an electronic business card case that can generate and store a digital image of a business card.

To accomplish the foregoing objective, the electronic business card case in accordance with the present invention comprises a body, an image scanning device and an image processing circuit.

The image scanning device is mounted inside the body and generates a digital image of a business card.

The image processing circuit is mounted inside the body, is connected electrically to the image scanning device and has a digital signal processor, an input unit, an output unit, a memory card slot, a communication interface and a power unit.

The digital signal processor has multiple input ports, multiple output ports and built-in character recognition software.

The input unit is connected electrically to one of the input ports of the digital signal processor.

The output unit is connected electrically to one of the output ports of the digital signal processor.

The memory card slot is connected electrically to the digital signal processor to store digital images generated by the image scanning device.

The communication interface is connected electrically to the digital signal processor and connects to external memory.

The power unit is connected electrically to the digital signal processor to supply power to the electronic business card case.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an electronic business card case in accordance with the present invention;

FIG. 2 is a cross section top view of the electronic business card case in FIG. 1;

FIG. 3 is a block diagram of the electronic business card case in FIG. 1; and

FIG. 4 is a perspective view of a second embodiment of an electronic business card case in accordance with the present invention.

### DETAILED DESCRIPTION OF THE PREFERRED EMBODIMENT

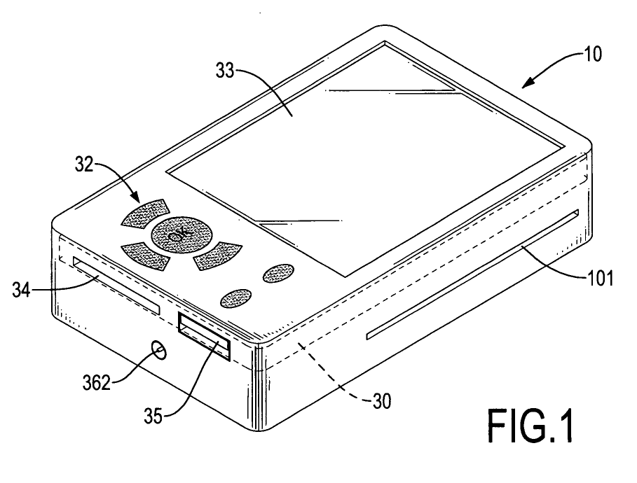

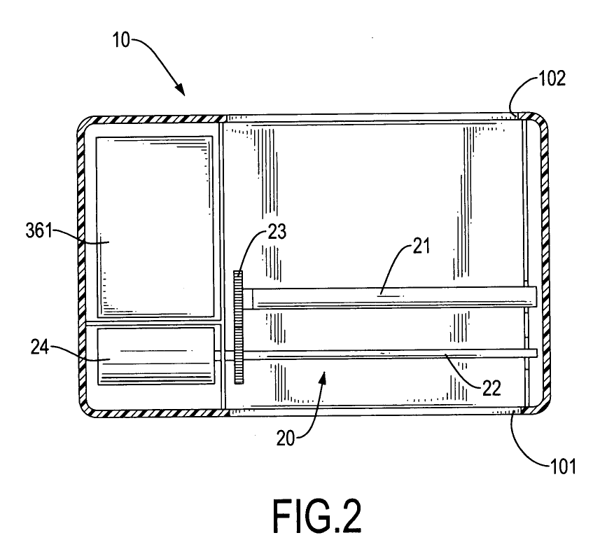

With reference to FIGS. 1, 2 and 4, an electronic business card case in accordance with the present invention comprises a body (10), an image scanning device (20) and an image processing circuit (30).

The body (10) comprises a top, a bottom, a front, a periphery, a card input slot (101) and a card discharge slot (102).

The periphery is formed around the body (10) and has a front sidewall and a rear sidewall.

The card input slot (101) is formed through the front sidewall.

The card discharge slot (102) is formed through the rear sidewall.

The image scanning device (20) is mounted inside the body (10) to generate a digital image of a business card and may be implemented with a motor (24), a drum scanner (21), a card input roller (22) and a gear assembly (23).

The motor (24) is mounted inside the body (10) near the front sidewall.

The drum scanner (21) is mounted inside the body (10) and corresponds to the card input slot (101).

The card input roller (22) is mounted inside the body (10) between the card input slot (101) and the drum scanner (21), is connected to and rotated by the motor (24) and drives a business card inserted through into the card input slot (101) over the drum scanner (21), through the body (10) and out the card discharge slot (102).

The gear assembly (23) is mounted on the drum scanner (21) and the card input roller (22), rotates when the card input roller (22) rotating and rotates the drum scanner (21) to scan a business card that passes over the drum scanner (21).

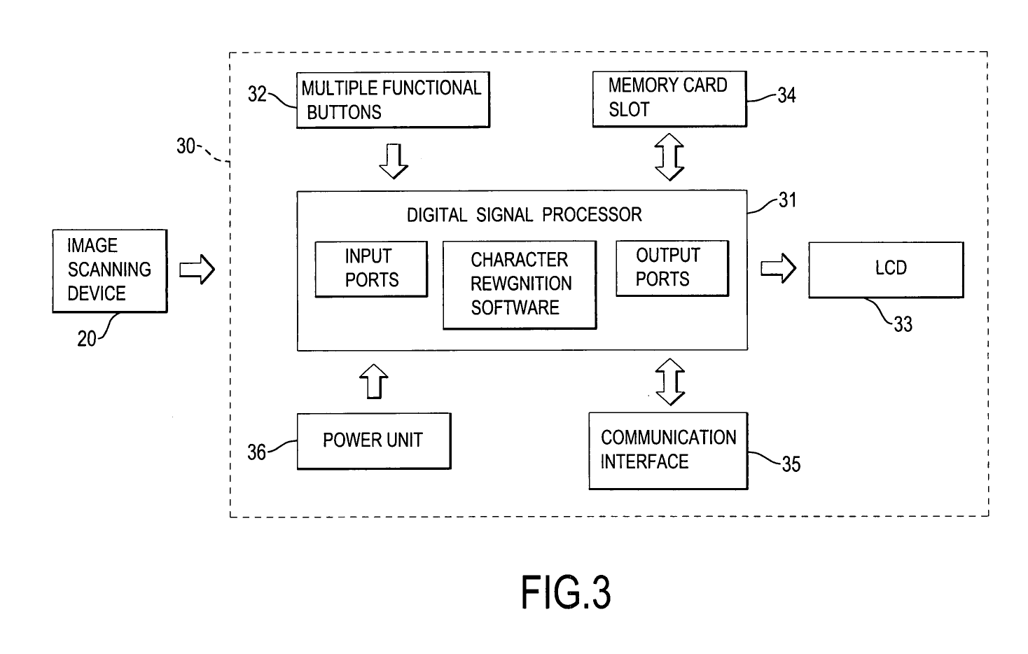

With further reference to FIG. 3, the image processing circuit (30) is mounted inside the body (10), is connected electrically to the image scanning device (20) and comprises a digital signal processor (31), an input unit, an output unit, a memory card slot (34), a communication interface (35) and a power unit (36).

The digital signal processor (31) has multiple input ports, multiple output ports and built-in character recognition software. The character recognition software processes the digital images and saves character data from the digital image in an appropriate database format (ex: dbase, csv, vcard, outlook, outlook express).

The input unit is connected electrically to one of the input ports of the digital signal processor (31) and may be implemented with the multiple function buttons (32). The function buttons (32) are mounted on the front of the body (10) and allow a digital image to be numbered, checked or deleted.

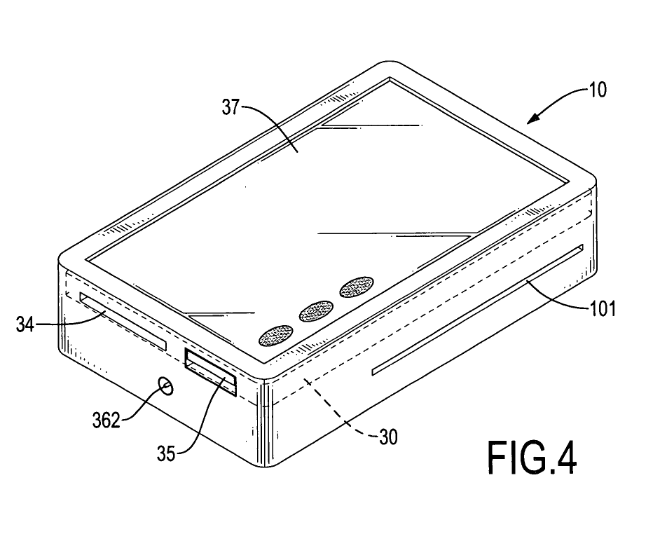

With further reference to FIG. 4, the output unit is connected electrically to one of the output ports of the digital signal processor (31), may be implemented with a liquid crystal display (LCD) (33) to directly view digital images and integrates the functions of the input unit as a touch screen (37) mounted on the front of the body (10).

The memory card slot (34) is formed in the periphery of the body (10), is connected electrically to the digital signal processor (31) to store digital images generated by the image scanning device (20) and can be a specification such as CF, SM, MS, MMS, SD, XD, etc.

The communication interface (35) is mounted in the periphery of the body (10), is connected electrically to the digital signal processor (31), connects to an external device such as a computer and may be a universal series bus (USB) interface. A digital image can be downloaded from or uploaded to the external device through the communication interface (35).

The power unit (36) is connected electrically to the digital signal processor (31) to supply power to the electronic business card case and may be implemented with a rechargeable battery assembly (361) and an external power input terminal (362).

The rechargeable battery assembly (361) is mounted inside the body (10).

The external power input terminal (362) is mounted in the periphery of the body (10) and connects to an external power source to supply power to the electronic business card and simultaneously charge the rechargeable battery assembly (361).

Whereby, the electronic business card case enable a user to directly view and edit the digital image, process the digital image to database format and store to an external memory card via the memory card slot and uploaded to or downloaded from an external device via the communication interface.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

1. An electronic business card case comprising:
a body comprising
a top;
a bottom;
a front;
a periphery formed around the body and having
a front sidewall;
a rear sidewall;
a card input slot formed through the front sidewall; and
a card discharge slot formed through the rear sidewall;
an image scanning device mounted inside the body to generate a digital image of a business card and implemented with
a motor mounted inside the body near the front sidewall;
a drum scanner mounted inside the body and corresponding to the card input slot;
a card input roller mounted inside the body between the card input slot and the drum scanner, connected to and rotated by the motor to drive a business card inserted into the card input slot over the drum scanner, through the body and out the card discharge slot; and
a gear assembly mounted on the drum scanner and the card input roller, rotating when the card input roller rotates and rotating the drum scanner to scan a business card that passes over the drum scanner; and
an image processing circuit mounted inside the body, connected electrically to the image scanning device and comprising
a digital signal processor having
multiple input ports;
multiple output ports; and
built-in character recognition software for processing digital images and saving character data from the digital image in an appropriate database format;
an input unit connected electrically to one of the input ports of the digital signal processor;
an output unit connected electrically to one of the output ports of the digital signal processor;
a memory card slot formed in the periphery of the body and being connected electrically to the digital signal processor to store digital images generated by the image scanning device;
a communication interface mounted in the periphery of the body, connected electrically to the digital signal processor for connecting an external device, so a digital image can be downloaded from or uploaded to the external device through the communication interface; and
a power unit connected electrically to the digital signal processor to supply power to the electronic business card case.

2. (canceled)

3. The electronic business card case as claimed in claim 1, wherein the communication interface is a universal series bus interface.

4. The electronic business card case as claimed in claim 1, wherein the output unit is a liquid crystal display mounted on the front of the body.

5. The electronic business card case as claimed in claim 1, wherein the input unit is multiple function buttons mounted on the front of the body.

6. The electronic business card case as claimed in claim 1, wherein the output unit integrates input unit functions in a touch screen mounted on the front of the body.

7. The electronic business card case as claimed in claim 1, wherein the power unit is the rechargeable battery assembly mounted inside the body.

8. (canceled)

9. (canceled)

10. (canceled)

11. (canceled)

12. (canceled)

13. The electronic business card case as claimed in claim 7, wherein the power unit further comprises an external power input terminal mounted in the periphery of the body.

14. (canceled)
